(19) United States
(12) Patent Application Publication
(10) Pub. No.: US 2014/0211403 A1
(43) Pub. Date: Jul. 31, 2014

(54) MOUNTING DEVICE FOR EXPANSION CARD

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: Song MA, Shenzhen (CN); Li-Ren FU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/830,628

(22) Filed: Mar. 14, 2013

(30) Foreign Application Priority Data
Jan. 30, 2013 (CN) 201310035627.6

(51) Int. Cl. G06F 1/18

(52) U.S. Cl. CPC G06F 1/185
USPC 361/679.32

(57) ABSTRACT

A mounting device for fixing an expansion card having an edge connector includes a motherboard and a fixing member mounted on the motherboard. An expansion slot is mounted on the motherboard. The fixing member includes a connecting portion, two blocks connected to opposite ends of the connecting portion, a resilient portion extending from the connecting portion away from the expansion slot, a protrusion protruding from the resilient portion. An L-shaped hook extends from a top of each block. The expansion card is limited by the connecting portion and the hooks, with the edge connector engaged in the expansion slot, and another end of the expansion card opposite to the edge connector blocked by the protrusion.

### BACKGROUND

1. Technical Field

The present disclosure relates to a device for mounting an expansion card.

2. Description of Related Art

Expansion cards parallel to motherboards are often mounted to the motherboards by screws to ensure secure mounting, which is time consuming in installing or uninstalling the expansion cards.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled, isometric view of an exemplary embodiment of a mounting device, together with an expansion card.

FIG. 2 is an exploded, isometric view of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

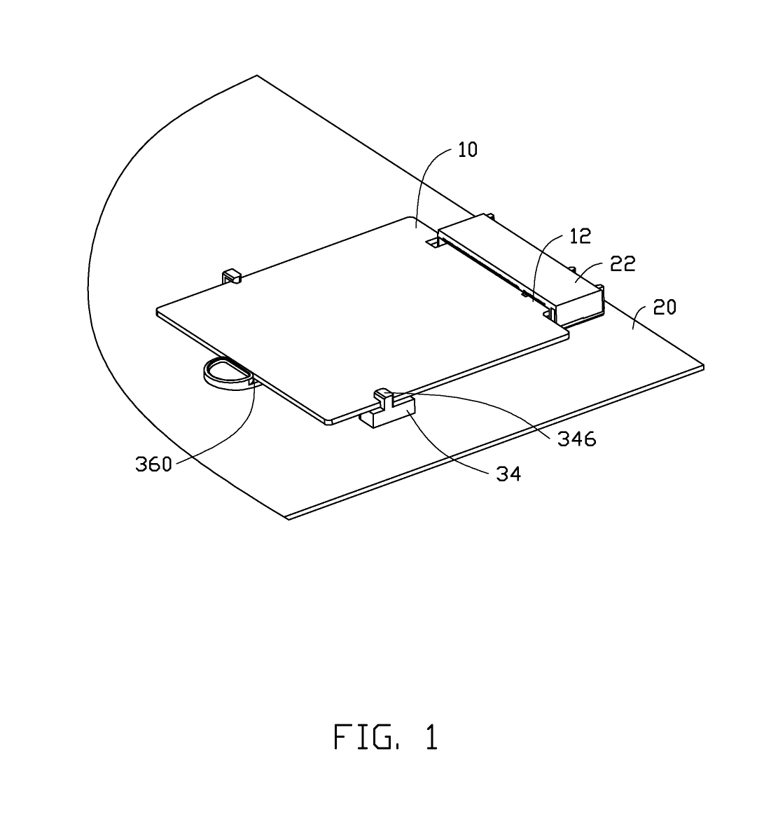

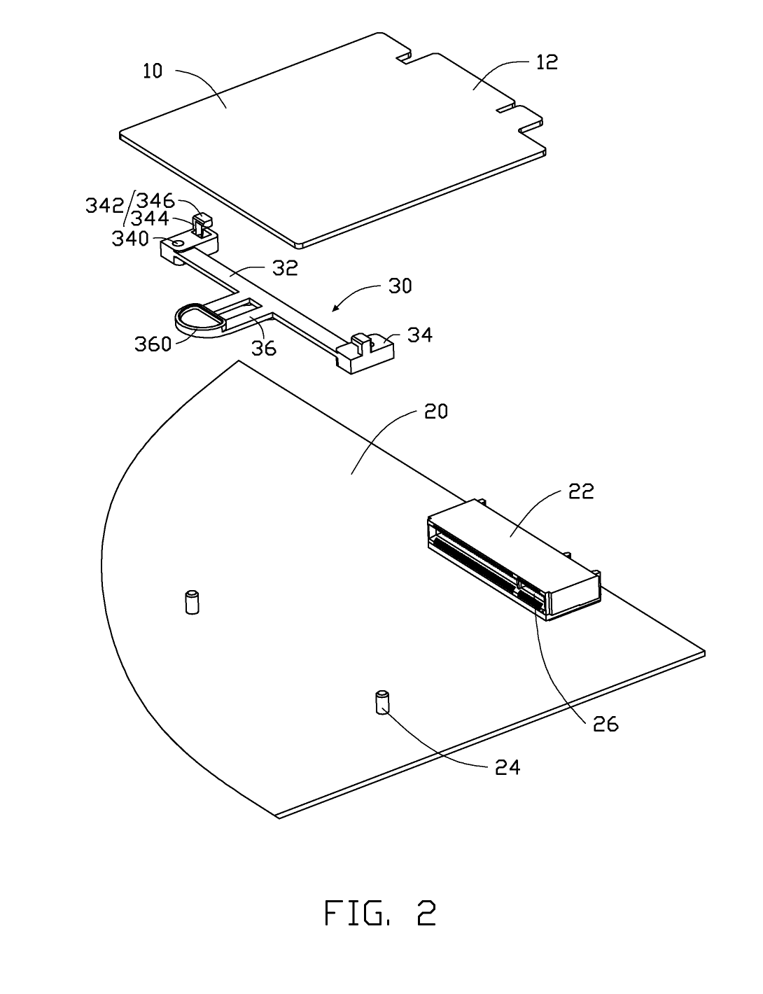

Referring to FIGS. 1 and 2, an exemplary embodiment of a mounting device is provided for fixing an expansion card 10 to a motherboard 20. The expansion card 10 forms an edge connector 12 at an end. The mounting device includes the motherboard 20 and a fixing member 30.

An expansion slot 22 and two standoffs 24 are mounted to the motherboard 20. The expansion slot 22 defines a slot 26 in a side perpendicular to a surface of the motherboard 20 and facing the standoffs 24.

The fixing member 30 includes a connecting portion 32, two blocks 34 connected to opposite ends of the connecting portion 32, a resilient portion 36 perpendicularly extending from a middle of the connecting portion 32, a protrusion 360 protruding up from a distal end of the resilient portion 36 away from the connecting portion 32. Each block 34 defines a through hole 340 extending through a top and a bottom of the block 34. Two substantially L-shaped hooks 342 extend from tops of the blocks 34 and face each other. Each hook 342 includes a pole 344 perpendicularly extending up from the corresponding block 34 and an arm 346 perpendicularly extending from a top end of the pole 344 toward the other block 34.

Referring to FIG. 1, in assembly, the through holes 340 fit about the standoffs 24, until the blocks 34 contact a top of the motherboard 20. The resilient portion 36 extends away from the expansion slot 22 and is deformed toward the motherboard 20. The expansion card 10 is slid through a space among the hooks 342 and the connecting portion 32, the resilient portion 36 is deformed toward the motherboard 20 by pressing the protrusion 360, until the edge connector 12 is inserted into the slot 26. The resilient portion 36 is then released to allow the protrusion 360 to abut against another end of the expansion card 10 away from the edge connector 12. Therefore, the expansion card 10 is limited by the connecting portion 32, the poles 344, and the arms 346.

In uninstalling the expansion card 10, the resilient portion 36 is deformed toward the motherboard 20. The expansion card 10 is pulled away from the expansion slot 22 disengaging the edge connector 12 from the slot 26.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A mounting device for mounting an expansion card having an edge connector, the mounting device comprising:
a motherboard comprising an expansion slot mounted on the motherboard, the expansion slot defining a slot in a side perpendicular to a surface of the motherboard to detachably receive the edge connector of the expansion card; and
a fixing member mounted on the motherboard, and comprising a connecting portion, two blocks connected to opposite ends of the connecting portion, a resilient portion extending from the connecting portion away from the expansion slot, and a protrusion protruding up from the resilient portion, two substantially L-shaped hooks facing toward each other extending from tops of the blocks; wherein the connecting portion and the hooks together limit the expansion card, and the protrusion abuts against an end of the expansion card away from the edge connector, in response to the edge connector being engaged in the slot.

2. The mounting device of claim 1, wherein each block defines a through hole, two standoffs protrude from the motherboard and are engaged in the through holes.
